(19) United States
(12) Patent Application Publication
(10) Pub. No.: US 2009/0207824 A1
(43) Pub. Date: Aug. 20, 2009

(54) Wireless Access Point Device

(75) Inventors: Thomas H. Lee, Burlingame, CA (US); Michael Palladino, San Carlos, CA (US); Bendik Kleveland, Santa Clara, CA (US); Vinay Malekal, San Ramon, CA (US)

Correspondence Address: THE MUELLER LAW OFFICE, P.C., 12951 Harwick Lane, San Diego, CA, 92130, US

(73) Assignee: ZeroG Wireless, Inc., Sunnyvale, CA (US)

(21) Appl. No.: 12/390,359

(22) Filed: Feb. 20, 2009

Related U.S. Application Data
(60) Provisional application No. 61/034,243, filed on Mar. 6, 2008.
(60) Provisional application No. 61/030,198, filed on Feb. 20, 2008.

(51) Int. Cl. H04W 84/02

(52) U.S. Cl. 370/338

(57) ABSTRACT

A wireless (such as Wi-Fi or similar) access point is included in or attached to a device, such as a cellular phone, WiMAX device, other mobile device, etc. One or more wireless units wirelessly access a communication network (and in some cases the Internet) through the wireless access point device. Additionally, such a wireless access point device can receive a transmission from a wireless tag that has been attached to an object to be monitored and can forward information from the wireless tag to a target device along with location information.

### CROSS-REFERENCE TO RELATED APPLICATIONS

This patent document claims priority to Provisional Patent Application No. 61/034,243 filed Mar. 6, 2008, and Provisional Patent Application No. 61/030,198 filed Feb. 20, 2008, under 35 U.S.C. §119(e), both of which are incorporated herein by reference in their entirety.

### BACKGROUND OF THE INVENTION

A Wi-Fi enabled device such as a personal computer (PC), game console, cell phone, MP3 player, personal digital assistant (PDA), mobile internet device (MID), etc. can access the Internet when within range of a Wi-Fi access point that is connected to the Internet. Wi-Fi access points that also include routers further allow multiple Wi-Fi enabled devices to connect to the Internet simultaneously. Such Wi-Fi access points have been set up in many places throughout the world in homes, offices, businesses and schools, among other sites. Some have been configured to be private, allowing access only to specific users, such as in homes and offices. Other Wi-Fi access points (also known as “hotspots”) have been configured to be publicly available either free of charge or with a paid subscription. Organizations and businesses such as airports, hotels and restaurants often provide free hotspots to attract or assist customers and clients. Enthusiasts or authorities who wish to provide services or even to promote business in a given area sometimes provide free Wi-Fi access to attract people. Metropolitan-wide Wi-Fi (Muni-Fi) has also been created in many cities for the use of residents or visitors.

Wi-Fi coverage is not as common as is cell phone coverage. Therefore, it is possible to connect a device (such as a PC, game console, MP3 player or PDA) to the Internet in many more locations using a cell phone (that has Internet access capability) than using Wi-Fi. It is presently rather cumbersome, however, to connect the device to the internet through a cell phone. Few cell phones have this capability, and those that do require a connecting cable between the device and the cell phone. The user, therefore, has to carry the cable along with the cell phone and the other device and has to find a place where the cell phone, cable and device can be laid out and connected together.

Additionally, although cell phones with Wi-Fi capability exist today, the Wi-Fi devices are regarded as client devices themselves. Such cell phones include a simple Wi-Fi adapter for the user to make use of VoIP (voice over Internet protocol) services through a nearby Wi-Fi access point, independently of the cellular network. As such, the Wi-Fi devices in these cell phones are actually somewhat competitive with the cell phones proper. Additionally, the Wi-Fi capabilities of these cell phones are unnecessarily redundant for users who also have a Wi-Fi enabled PDA or notebook PC, with which they can use VoIP services.

### BRIEF DESCRIPTION OF THE DRAWINGS

FIG. 1 is a simplified diagram of a network that allows access by wireless units through a communication network according to an embodiment of the present invention.

FIG. 2 is a simplified schematic diagram of a wireless access point device with an attachable/detachable device that enables network access by wireless units shown in FIG. 1 according to an embodiment of the present invention.

FIG. 3 is a simplified schematic diagram of a wireless access point device that enables network access by wireless units shown in FIG. 1 according to an embodiment of the present invention.

FIG. 4 is a simplified schematic diagram of another wireless access point device that enables network access by wireless units shown in FIG. 1 according to an embodiment of the present invention.

FIG. 5 is a simplified diagram of a networked system incorporating the wireless access point device with an attachable/detachable device shown in FIG. 2 or either of the wireless access point devices shown in FIGS. 3 and 4 according to an embodiment of the present invention.

FIG. 6 is a simplified schematic diagram of a wireless enabled tag for use in the networked system shown in FIG. 5 according to an embodiment of the present invention.

FIG. 7 is another simplified diagram of a networked system incorporating the wireless access point device with an attachable/detachable device shown in FIG. 2 or either of the wireless access point devices shown in FIGS. 3 and 4 according to an embodiment of the present invention.

### DETAILED DESCRIPTION OF THE INVENTION

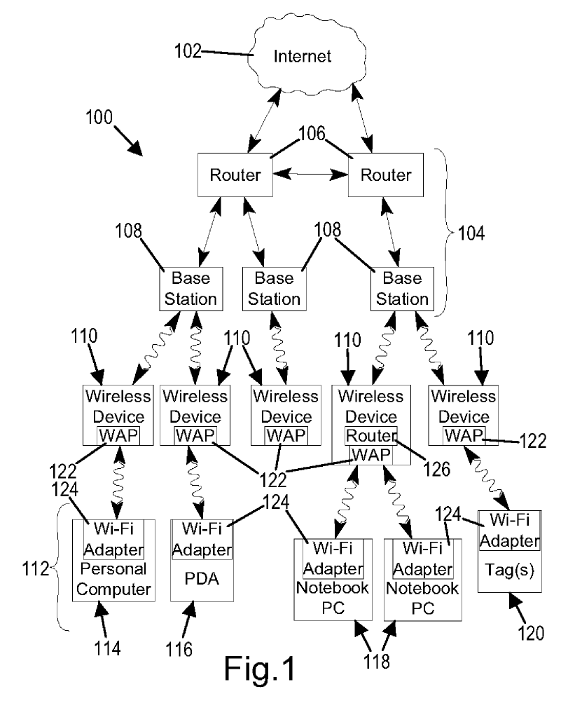

A network 100, as shown in FIG. 1, incorporating an embodiment of the present invention for accessing the Internet 102 and performing other tasks described herein generally includes a wireless communication network 104 (e.g. including various routers 106, base stations 108 and other equipment), a variety of wireless access point devices 110 and a variety of wireless units 112. The communication network 104 is preferably a conventional cellular telephone network, a WiMAX (Worldwide Interoperability for Microwave Access) network, an IEEE 802.xx standard network, a “Broadband Wireless Access” network, a telephone network, a data network or the like. The wireless access point devices 110 are preferably a variety of cell phones, PDAs, WiMAX devices, Wi-Fi routers, modems, cordless phones, etc. with “additional” wireless capabilities, such as Wi-Fi, Bluetooth, RFID, AMP (Alternate MAC PHY), Wireless USB, Zigbee, etc. (In some embodiments, however, the wireless access point devices 110 are replaced by a land/line-based (i.e. not wireless) telephone or modem, and the communication network 104 includes appropriate telephone system components.) The wireless units 112 are preferably a variety of personal computers 114, PDAs 116, notebook PCs 118, wireless-enabled tags 120 and/or other electronic devices that have wireless components/functions, such as Wi-Fi, Bluetooth, RFID, AMP (Alternate MAC PHY), Wireless USB, Zigbee, etc. Additionally, according to some, but not all, embodiments, the wireless access point devices 110 and wireless units 112 are preferably mobile devices.

The wireless access point devices 110 each incorporate a wireless access point circuitry (WAP) 122 (e.g. Wi-Fi, Bluetooth, RFID, etc.) for enabling wireless communication functionality. The wireless units 112 each include a wireless adapter 124 (e.g. Wi-Fi, Bluetooth, RFID, etc.). Each wireless access point device 110, thus, can be configured to accept wireless access or communication by one or more of the wireless units 112.

The wireless units 112, therefore, can access the Internet 102 and perform other networking functions through the wireless access point devices 110 and the communication network 104 anywhere cellular or WiMAX or similar coverage is available, but without having to lay out any equipment and plug in a cumbersome cable. In fact, due to already widespread cellular coverage and anticipated cellular or WiMAX or similar coverage, once a user's wireless access point device 110 is set up to allow Wi-Fi (or similar) access for the user's wireless unit 112 the user will experience seamless, almost ubiquitous Internet availability wherever the user goes. This widespread, seamless, almost ubiquitous Internet availability is enabled by the invention described herein because the user's wireless unit 112 and wireless access point device 110 can automatically establish the connection between them and the further connection to the communication network 104 and on to the Internet 102 without the user having to do anything more than simply turning the devices (110 and 112) on at almost any location. Additionally, in embodiments in which the wireless access point device 110 is a cordless phone (or in some cases in which the wireless access point device 110 is replaced by a land/line-based telephone or modem connected to a standard local telephone network), the wireless units 112 can access the Internet 102 and perform other networking functions described below through the standard local telephone network.

Additionally, the Wi-Fi (or similar) capability of the wireless access point devices 110 is an “added”, rather than a “competitive”, function to the cellular or WiMAX or similar function of the wireless access point devices 110. Therefore, according to one example, network providers, such as cellular network service providers, who often serve as resellers of cell phones, have an incentive to encourage adoption of Wi-Fi (or similar) enabled cell phones by their customers, who gain a beneficial ease-of-use function in their cell phones, while the service providers gain more users and increased usage of their networks. Service providers for other wireless access point devices 110 (e.g. WiMAX) have a similar incentive to encourage adoption of Wi-Fi (or similar) enabled wireless access point devices 110.

In addition to the WAP 122, according to some embodiments, some of the wireless access point devices 110 also include an optional router 126. In this case, multiple wireless units 112 can simultaneously use the Wi-Fi (or similar) capabilities of one wireless access point device 110. For example, if multiple people are riding together in one car, and one of them has the wireless access point device 110 with Wi-Fi (or similar) capabilities along with the router 126, then any or all of them can use their wireless units 112 at the same time to perform any Wi-Fi (or similar) enabled task, such as browsing the Internet 102, checking/sending email, updating blogs, uploading photos, etc.

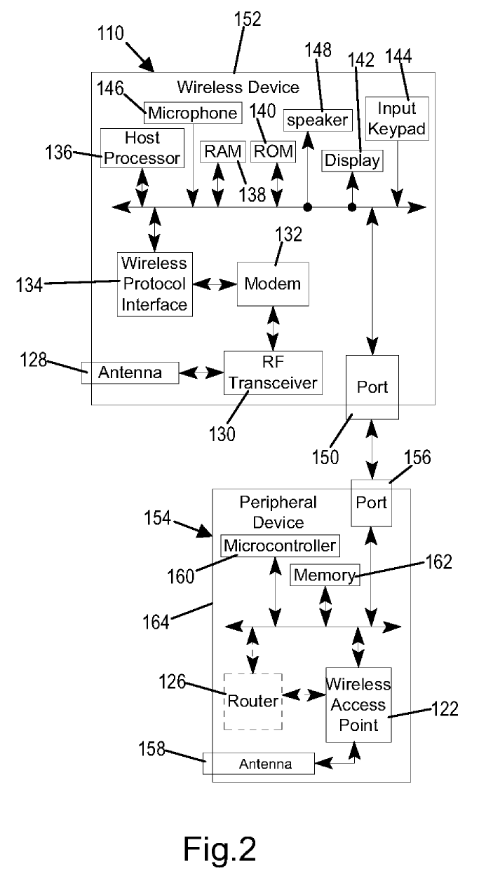

According to various embodiments, the wireless access point device 110, as shown in FIGS. 2, 3 and 4, generally includes typical wireless communication components, such as communication and control circuitry. For example, in the case of a cell phone, WiMAX device or cordless phone, the wireless access point device 110 generally includes an antenna 128, an RF (radio frequency) transceiver 130, a modem 132, a wireless protocol interface 134, a host processor 136, a RAM (random access memory) 138, a ROM (read only memory) 140, a display 142, an input keypad 144, a microphone 146 and a speaker 148. (The wireless access point device 110 may also include various other features, such as a camera, a video player, etc.)

According to the embodiment shown in FIG. 2, the wireless access point device 110 further preferably includes a port 150 for connecting add-on or peripheral devices to the wireless access point device 110. The port 150 may be of a proprietary design or may support a standard interface, such as SDIO (Secure Digital Input Output), SPI (Serial Peripheral Interface Bus), USB (Universal Serial Bus), FireWire (IEEE 1394), various flash media readers, other standard serial interfaces, etc.

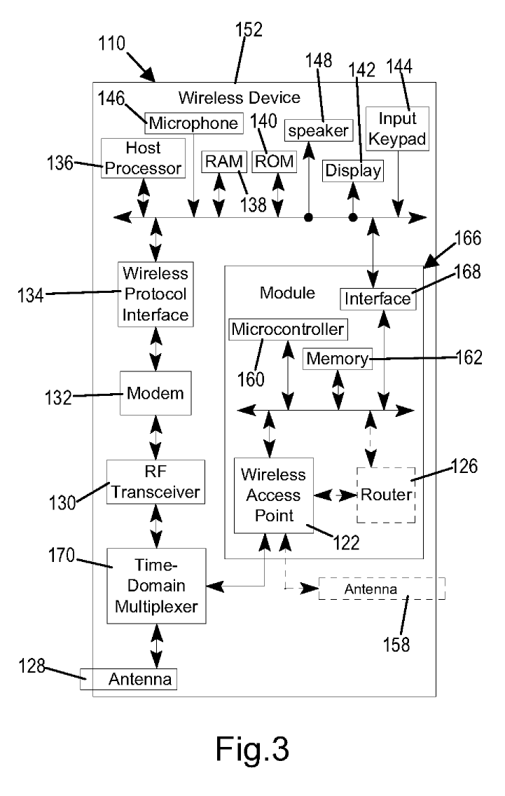

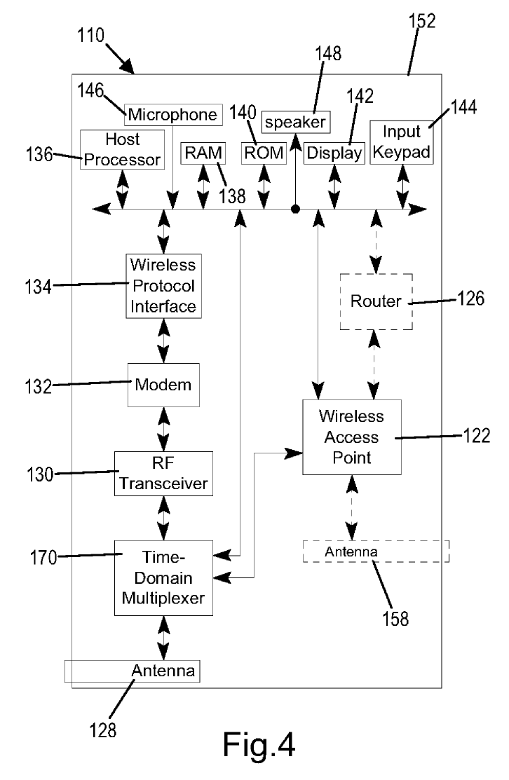

These components and features (128-150) are preferably assembled and interconnected in an appropriate manner within or onto a housing 152 on one or more circuit boards. The antenna 128 is preferably disposed inside, outside or partially inside/outside the housing 152. Additionally, the port 150 is preferably accessible at an opening in a side of the housing 152. According to the embodiments shown in FIGS. 3 and 4, the port 150 is optional and, for simplicity, not shown.

In the particular embodiment shown in FIG. 2, the Wi-Fi (or similar) capabilities of the wireless access point device 110 are incorporated in a peripheral device 154. The WAP 122 is thus preferably included within the peripheral device 154 along with a port 156. The port 156 of the peripheral device 154 is electrically connected to the wireless access point device 110 at the port 150. The port 156 and the peripheral device 154 may thus be of a proprietary design, but are preferably constructed to comply with one or more various standards, such as SDIO, SPI, USB, FireWire, various flash media readers, other standard serial interfaces, etc., that many available wireless access point devices 110 support or may eventually support. In this manner, the peripheral device 154 can electrically and physically connect to a variety of the wireless access point devices 110 at the port 150. Upon physically connecting the peripheral device 154 to the wireless access point device 110, a link, such as a serial communication link, through the ports 150 and 156 can thus be established between the wireless access point device 110 and the peripheral device 154.

In addition to the WAP 122 and the port 156, the peripheral device 154 includes the optional router 126, an antenna 158, an optional microcontroller 160 and an optional memory 162. The microcontroller 160 and the memory 162 may be a general-purpose processor with a RAM or ROM, a specially designed ASIC (application specific integrated circuit) or any other appropriate circuitry. These components and features are preferably assembled and interconnected in an appropriate manner on one or more circuit boards within a housing 164. The antenna 158 is preferably inside, outside or partially inside/outside the housing 164. Additionally, the port 156 is preferably accessible at an opening in or protrudes out of a side of the housing 164.

In the particular embodiments shown in FIGS. 3 and 4, the Wi-Fi (or similar) capabilities of the wireless access point device 110 are incorporated in or on an integrated circuit (IC) or a circuit board that also incorporates most, if not all, of the other components (128-148) of the wireless access point device 110 as described above. Therefore, the WAP 122, the optional router 126 and the antenna 158 are incorporated into the housing 152 of the wireless access point device 110 along with the components (128-148). The antenna 158 is preferably disposed inside, outside or partially inside/outside the housing 152.

In the case of the embodiment shown in FIG. 3, the microcontroller 160 and the memory 162 are also incorporated in or on an integrated circuit (IC) or a circuit board that also incorporates most, if not all, of the other components (128-148) of the wireless access point device 110. According to variations of this embodiment, the Wi-Fi (or similar) components (122, 126, 158, 160, 162), or portions thereof, of the wireless access point device 110 are designed in a module 166 separate from the other components (128-148). The module 166 also preferably includes an interface 168, such as a proprietary or standard serial or parallel bus interface. The interface 168 enables the Wi-Fi (or similar) components of the wireless access point device 110 to interact with the other components (128-148) that are either in the same IC or on the same circuit board.

The module 166 may be described in a hardware descriptive language (HDL) module, such as a Verilog module. As such, the module 166 can be incorporated with other HDL modules that describe some or all of the other components (128-148) of the wireless access point device 110. In this manner, the module 166 can be designed separately from the other components (128-148) and then compiled with other HDL modules for the design, verification, and implementation of digital logic chips and/or mixed-signal circuits that form some or all of the electronic components of the wireless access point device 110. Creation and use of such a module 166, therefore, enables relatively quick and easy incorporation of Wi-Fi (or similar) capabilities, as described herein, into a variety of the wireless access point devices 110 made by different manufacturers.

The WAP 122 and the optional router 126 preferably include circuitry typically required for the functions thereof. Such circuitry can already be placed in relatively small form factors, such as PC Cards and USB plug-ins, among other form factors. Therefore, similar techniques may be used for the incorporation of this circuitry and other components described herein into the peripheral device 154 or in or on an IC or circuit board within the housing 152 of the wireless access point device 110.

According to some embodiments, the microcontroller 160 generally controls the functions of the peripheral device 154 or the module 166, while the host processor 136 generally controls the functions of the wireless access point device 110. Therefore, the microcontroller 160 controls the Wi-Fi (or similar) capabilities of the wireless access point device 110, while the host processor 136 turns on/off and operates various other functions of the wireless access point device 110 according to the desires of the user. As a result of this division of activities, it is estimated that variations on a driver running on the host processor 136 to enable the wireless access point device 110 to interface with the peripheral device 154 or the module 166 would require less than 1 MB of the RAM 138 and less than 1 MB of ROM 140 or less than 1 MB of either or both. Therefore, adding Wi-Fi (or similar) capabilities to the wireless access point device 110 by attaching the peripheral device 154 thereto or adding the module 166 therein would not put an undue burden on the operation of the wireless access point device 110 and would not necessarily require a redesign of already-available wireless access point devices 110.

In the embodiment shown in FIG. 4, the WAP 122 and the router 126 are controlled directly by the host processor 136, rather than by a separate microprocessor. In this case, a driver running on the host processor 136 to enable the wireless access point device 110 to use the Wi-Fi (or similar) capabilities thereof may require more space in the RAM 138 (or ROM 140) and more processing cycles of the host processor 136 than does the driver in the previous embodiments. Therefore, this embodiment may take less space in the wireless access point device 110, but may more noticeably affect the operation thereof.

Additionally, the wireless access point device 110 and/or the peripheral device 154 or the module 166 preferably use a memory management technique similar to the one disclosed in co-pending U.S. patent application Ser. No. 12/037,943, filed Feb. 27, 2008, which is hereby incorporated herein by reference in its entirety. Furthermore, the wireless access point device 110 and/or the peripheral device 154 or the module 166 preferably use a virtual memory interface technique similar to the one disclosed in co-pending U.S. patent application Ser. No. 12/037,940, filed Feb. 26, 2008, which is hereby incorporated herein by reference in its entirety.

According to some embodiments, the host processor 136 preferably controls whether the wireless access point functionality and the optional router functionality of the wireless access point device 110 are activated in accordance with user settings. In this manner, the user may select for the wireless access point device 110 to grant access to one or more specified wireless units 112 (FIG. 1) according to specific passwords or to serve as a “hotspot” for any wireless units 112.

Additionally, some wireless units 112 (FIG. 1) may automatically connect to certain Wi-Fi (or similar) access points, as in the case of a personal computer located in a home or office that has a Wi-Fi (or similar) access point. Therefore, the wireless access point device 110 can be configured to automatically grant Wi-Fi (or similar) access and Internet access to specific (or all) wireless units 112 in the same manner as other Wi-Fi (or similar) access points do.

In an exemplary situation, therefore, when a user turns on a wireless unit 112 (FIG. 1), the wireless unit 112 scans for available Wi-Fi (or similar) access points. If the wireless unit 112 finds more than one Wi-Fi (or similar) access point, the wireless unit 112 preferably initially attempts to gain access through whichever one is a “primary” Wi-Fi (or similar) access point. Such a situation may occur when a user uses the wireless unit 112 and the wireless access point device 110 in a home or office setting where there is installed a Wi-Fi (or similar) access point and a router that is connected to a relatively fast data land-line. It may be assumed (though not always) that in such a setting, a land-line would provide a faster data transfer speed than would a wireless connection through the wireless access point device 110. The wireless access point device 110 may, therefore, be treated by the wireless unit 112 as a “secondary” Wi-Fi (or similar) access point, which the wireless unit 112 does not attempt to access, unless no primary Wi-Fi (or similar) access point is available. Similarly, the wireless unit 112 may be configured to select a free public hotspot over the wireless access point device 110 due to either data transfer speed or cost, since the user may have to pay for time spent using the wireless access point device 110 for data transfer or Internet access.

In general, the order of priority in which the user's wireless unit 112 places the user's wireless access point device 110 preferably depends on known or anticipated data transfer speeds and costs associated therewith for each of the user's potential Internet or other network access options. When the user turns on the wireless unit 112, therefore, the connection to the Internet 102 can preferably be made “seamlessly”, i.e. without further interaction by the user, regardless of the user's physical location, as long as there is at least cell phone coverage in the area.

The router 126 is considered “optional” for some embodiments, because it is only needed if the user wants to allow multiple wireless units 112 to connect through the wireless access point device 110. Since the router 126 may raise the cost of the wireless access point device 110, the user may be satisfied without such additional functionality and be willing to have only one wireless unit 112 at a time connected to the wireless access point device 110.

In the embodiments shown in FIGS. 3 and 4, the antenna 158 is considered optional. The antenna 158 is not necessary in some variations of these embodiments due to the fact that, since the Wi-Fi (or similar) components (122, 126, 158, 160, 162) and the other components (128-148) are incorporated together in the housing 152 of the wireless access point device 110, the Wi-Fi (or similar) capabilities and the cellular (or WiMAX or similar) functions may both use the same antenna 128. In such cases, the wireless access point device 110 also includes a time-domain multiplexer 170. The time-domain multiplexer 170 switches the antenna 128 back and forth between the Wi-Fi (or similar) RF transmission/reception and the cellular (or WiMAX or similar) RF transmission/reception by selecting which of the RF transceiver 130 and the WAP 122 may use the antenna 128 at different periods of time. Also, the time-domain multiplexer 170 prevents interference between the two types of RF transmissions and receptions. Using a single antenna in this manner can decrease the size or number of the overall components in the wireless access point device 110, but may increase the complexity of some of these components. The overall cost of the wireless access point device 110 may vary, based on the size, number and complexity of these components, among other factors.

Having both antennas 128 and 158, on the other hand, enables the wireless access point device 110 to perform both the Wi-Fi (or similar) RF transmission/reception and the cellular (or WiMAX or similar) RF transmission/reception at the same time. In this case, greater data transfer bandwidth can be achieved with the two antennas 128 and 158 than with just the one antenna 128.

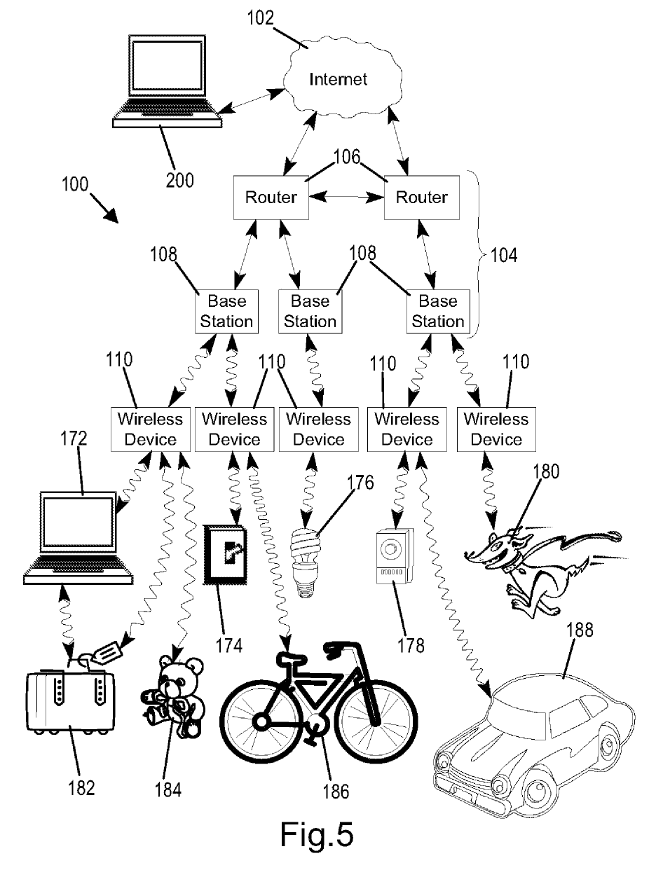

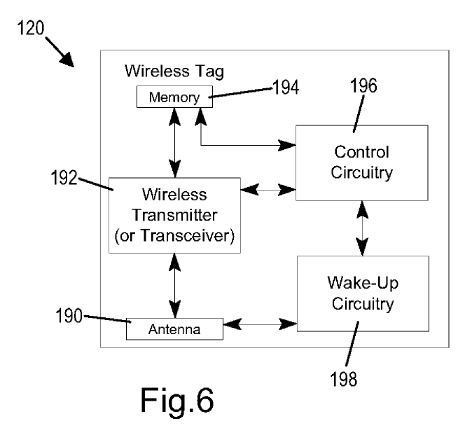

The wireless access point devices 110 enable other capabilities, some of which will now be described with reference to FIGS. 5, 6 and 7. According to some embodiments, the network 100 may be used to monitor, locate and/or interact with various objects, or “client” devices, many of which may be mobile. A representative non-exhaustive sample of such objects (e.g. a computer 172, a light switch 174, a light bulb 176, a thermostat 178, a pet 180, a piece of luggage 182, a toy 184, a bicycle 186 and a vehicle 188) is shown in FIG. 3. Each of these objects 172-188 has one of the wireless, e.g. Wi-Fi (or similar) enabled, tags 120 attached thereto. Each tag 120, as shown in FIG. 6, has at least a Wi-Fi (or similar) antenna 190, a wireless, e.g. Wi-Fi (or similar), transmitter (or transceiver) 192, a memory 194, a control circuitry 196, a wake-up circuitry 198 and a power source (not shown) therein.

Each of the tags 120 can be monitored by one or more of the wireless access point devices 110 (FIG. 5) or other wireless receiving devices, such as the computer 172, whether mobile or land-line based. Additionally, each of the wireless access point devices 110 or other wireless receiving devices 172 can monitor one or more of the tags 120.

The memory 194 (FIG. 6) stores identification information that identifies either the tag 120 or the object 172-188 to which it is attached or both. The memory 194 also stores target information that specifies a target device, e.g. one of the wireless access point devices 110, the tagged computer 172, an untagged computer 200 or other appropriate type of device. According to various embodiments, each tag 120 periodically, or occasionally, transmits its stored information via its Wi-Fi (or similar) capabilities. The memory 194 in each tag 120 acquires the identification information and the target information either when manufactured (as for a ROM) or when configured or reconfigured by a user (as for a RAM) through any appropriate means, such as with the control circuitry 196 upon receiving the identification information and the target information through the antenna 190 and the transmitter (or transceiver) 192.

Furthermore, according to some embodiments shown in FIG. 5, some of the objects (e.g. the computer 172, the light switch 174, the light bulb 176, the thermostat 178, etc.) may have a variety of status conditions, such as turned on, turned off, functioning properly, set to a desired value, etc. Status information indicative of the status of such objects 172-178, therefore, is gathered (and may be stored in the memory 194) by the control circuitry 196 of the tags 120 attached (or built in) to these objects 172-178. The status information is also periodically transmitted along with the identification and target information.

According to some embodiments shown in FIG. 5, a user's Wi-Fi (or similar) enabled wireless access point device 110 or other wireless receiving devices, such as the computer 172, are configured to receive these transmissions, thereby monitoring the tags 120 and the attached objects 172-188. Additionally, other Wi-Fi (or similar) enabled wireless access point devices 110 or other wireless receiving devices in the vicinity of the monitored tags 120 and objects 172-188 may also be configured to receive these transmissions and to forward the information to the user's wireless access point device 110 or other target device specified by the target information. Since the other Wi-Fi (or similar) enabled wireless access point devices 110 or other wireless receiving devices monitor the tags 120 in the absence of the user's wireless access point device 110 or other wireless receiving devices, the user can receive the desired information even when not within range of the monitored tags 120 and the attached objects 172-188.

For the objects 172-178 (FIG. 5) that have a monitored status condition, the user receives a message or alert of the status condition. For example, for the computer 172, the message or alert may show whether the computer 172 is turned on or turned off or suffered a crash, which may indicate to the user whether the computer 172 is functioning properly while the user is not immediately next to it and actively using it. The user can then be alerted to go reboot the computer 172 or take other appropriate action. The user may also, in some embodiments, send commands back to the monitored computer 172 from the user's wireless access point device 110 in order to control the computer 172 to some extent.

In another example, a worker with one of the wireless access point devices 110 in a facility (in which several workers carry the wireless access point devices 110) may monitor various objects (e.g. the lighting and air conditioning) within the facility regardless of whether the worker's cell phone is within range of the light switches 174, the light bulbs 176, the thermostats 178, etc. or is even within the facility. In some embodiments, the worker can then turn on or off the light switches 174, alter the thermostat 178 setting or send a text or voice message to order someone to change a burned-out light bulb 176 from the worker's wireless access point device 110, regardless of whether the worker is in the facility, at home, at another location or in transit.

As long as the user's wireless access point device 110 receives each periodic transmission, it is assumed that the object 172-188 is where it is supposed to be, i.e. near the user. If the monitored object 172-188 is lost, stolen or runs away (as in the case of the pet 180), then either the user (or the user's wireless access point device 110) moves away from the monitored object 172-188 or the object 172-188 moves away from the user's wireless access point device 110. In either case, according to some embodiments, the user's cell phone may generate a message or alert indicating to the user that the monitored object is no longer nearby when the wireless access point device 110 does not receive the transmission from the tag 120 after the period for transmission has passed. In various situations, the alert might mean that the user's luggage 182 is not on the same plane as the user, that the user's child has dropped the toy 184 somewhere, that the user's bicycle 186 or vehicle 188 has been stolen or that the user's pet 180 has escaped from the user's home. The user can then take appropriate action.

Since other people may have the wireless access point devices 110, it is preferable, according to some embodiments, for location information generated either by the wireless access point devices 110 or the communication network 104 (e.g. the routers 106, the base stations 108, etc.) to be attached to whatever information is forwarded to the user's wireless access point device 110 or other specified target device. The location information indicates the location of the wireless access point device 110 that forwarded the information from the tag 120 to the user's wireless access point device 110. It would thus be assumed that the approximate location of the tagged object 172-188 is the same as the location of the wireless access point device 110 that forwarded the information. The user can then take appropriate action to track down or retrieve the object 172-188.

In some situations, the user may expect that the monitored object 172-188 not be within range of the user's wireless access point device 110. For example, the user may park the bicycle 186 or vehicle 188 someplace and intentionally walk away from it. The user can then either ignore the alert that comes up on the wireless access point device 110 or can configure the wireless access point device 110 not to generate the alert. Additionally, the user would not want or need to be alerted to the location of the object 172-188 (e.g. the parked bicycle 186 or vehicle 188) every time someone with one of the wireless access point devices 110 walked passed the object 172-188. Therefore, according to some embodiments, the user's wireless access point device 110 (or other target device) can be configured not to generate an alert and/or to ignore the information forwarded from the tag 120 unless the attached location information has changed. The user then receives the alert only when necessary.

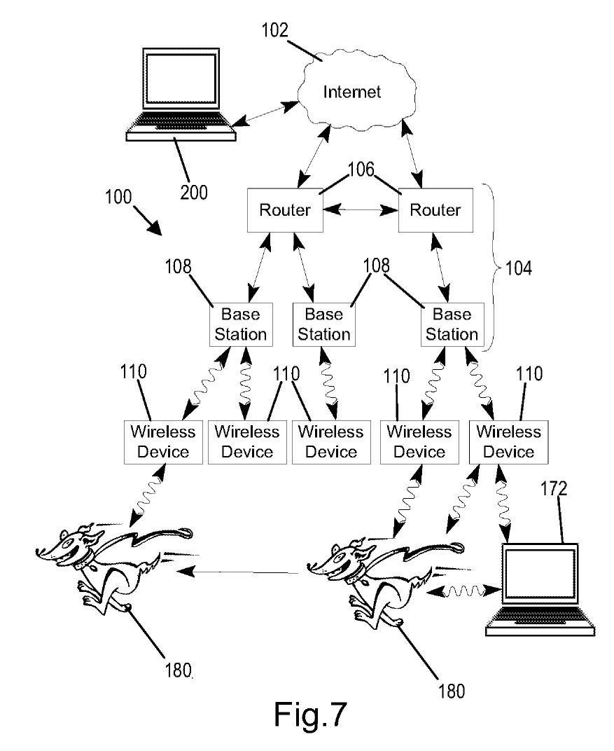

According to some embodiments, the user may have more than one device monitoring one or more of the objects 172-188, as shown in an exemplary situation in FIG. 7. In this example, the user has configured two of the wireless access point devices 110 and the tagged computer 172 to monitor the pet 180 at home. The user sets up one of the monitoring devices 110 or 172 or some other device (e.g. the untagged computer 200 connected through the Internet 102) to serve as the target device or as a primary monitoring device. It is conceivable that any of the monitoring devices 110 or 172 could leave the house with the user or some other person in the house. In this case, the leaving monitoring device 110 or 172 could potentially generate an alert that the pet 180 is missing, even though the pet 180 is still in the vicinity of the house. According to some embodiments, therefore, it is preferable for the user to be able to configure the target or primary monitoring device 110, 172 or 200 to ignore the alerts from other monitoring devices 110 or 172 if not all of the monitoring devices 110 or 172 has indicated that it is no longer receiving the transmission from the tag 120 attached to the pet 180. Then when the pet 180 wanders within range of another one of the wireless access point devices 110, the tag identification information will be forwarded along with the location information to the target device 110, 172 or 200. In this manner, the user does not receive a false alert, but only legitimate alerts.

Since the wireless access point devices 110 are preferably mobile devices in many embodiments, it is very likely that many of the wireless access point devices 110 will be battery-operated. In this case, therefore, power saving features may be activated in the wireless access point devices 110 when no data is being transferred through the WAP 122. In particular, when used as a monitor for the wireless tags 120, the wireless access point device 110 does not need to be fully powered-up all of the time, but only when it needs to receive the information from one of the wireless tags 120. Additionally, the wireless tags 120, also being mobile in many cases, are preferably battery-operated with power saving features too.

In an exemplary power saving technique, under control of a program running on the host processor 136 (FIGS. 2 and 3), the wireless access point device 110 signals one of more of the wireless tags 120 or other wireless units 112 that it is going into a sleep, hibernation or low-power mode. Upon receiving the signal, the control circuitry 196 in the wireless tags 120, or a processor in the other wireless units 112, causes the wireless tags 120 or the other wireless units 112 also to go into a sleep, hibernation or low-power mode. When it is time for one of the wireless tags 120 to transmit its information or the wireless access point device 110 has data to send to one of the wireless units 112, the wireless access point device 110 enters a higher-power mode (if it isn't already in the higher-power mode) and sends another signal to the wireless tag 120 or wireless unit 112. In this case, the wake-up circuitry 198 in the wireless tag 120 or similarly responsive circuitry in the wireless unit 112 senses the signal and causes the wireless tag 120 or the wireless unit 112 to enter its higher-power mode. Data transfer then commences between the wireless access point device 110 and the wireless tag 120 or the wireless unit 112. After the data transfer, the wireless access point device 110 and the wireless tags 120 or other wireless units 112 can reenter the sleep, hibernation or low-power mode as before.

In another exemplary power saving technique, the wireless access point device 110 (under control of a program running on the host processor 136) and the wireless tags 120 (under control of a routine in the control circuitry 196) or the wireless units 112 (under control of appropriate programs or circuitry) are synchronized to put themselves into the higher-power mode at periodic intervals or at certain times. In this case, any necessary data transfer may occur, followed by the wireless access point device 110 and the wireless tags 120 or the wireless units 112 putting themselves into the sleep, hibernation or low-power mode under appropriate internal controls.

In variations on power saving techniques, only the WAP 122 (FIGS. 2, 3 and 4) or only the optional router 126 or both enter a sleep, hibernation or low-power mode. In such variations, other functions of the wireless access point device 110 remain active, while the wireless access point capabilities are turned off or down.

In other variations, the wireless tags 120 or wireless units 112 enter their sleep, hibernation or low-power modes as necessary, while the wireless access point device 110 enters its sleep, hibernation or low-power mode when it hasn't received any transmissions from any of the wireless tags 120 or wireless units 112 for a specified period of time. A timer in the wake-up circuitry 198 in the wireless tags 120 or in the wireless units 112 causes the wireless tags 120 or wireless units 112 to enter higher-power mode periodically in order to transmit their data. The wireless access point device 110 then enters its higher-power mode when it senses the beginning of a transmission from one of the wireless tags 120 or wireless units 112.

Other power-saving methods are within the scope of the present invention.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

The invention claimed is:

1. A wireless access point device comprising:
a wireless communication circuitry with which a wireless connection is made to a wireless communication network; and
a wireless access point circuitry electronically connected to the wireless communication circuitry;
and wherein:
the wireless access point circuitry enables a wireless connection to be made between a wireless unit and the wireless access point device; and
the wireless access point circuitry enables the wireless unit to wirelessly access the wireless communication network using the wireless access point circuitry and the wireless communication circuitry.

2. The wireless access point device of claim 1, wherein the wireless access point device is a mobile device.

3. The wireless access point device of claim 1, wherein the wireless access point device enters a low-power mode when no data is being transferred between the wireless access point device and the wireless unit.

4. The wireless access point device of claim 1, further comprising:
a router electronically connected to the wireless access point circuitry and to the wireless communication circuitry for enabling a plurality of the wireless units to wirelessly access the wireless communication network through the wireless access point circuitry and the wireless communication circuitry.

5. The wireless access point device of claim 1, further comprising:
a host processor that controls functions of the wireless access point device;
a memory in which programs are stored for use by the host processor to control the functions of the wireless access point device; and
a program running on the host processor and contained in less than 1 MB of the memory, the program enabling the host processor to use the wireless access point circuitry.

6. The wireless access point device of claim 5, further comprising:
a microcontroller, separate from the host processor, that controls functions of the wireless access point circuitry.

7. The wireless access point device of claim 1, wherein:
the wireless access point circuitry is a module that is incorporated into a circuit design that includes the wireless communication circuitry.

8. The wireless access point device of claim 1, further comprising:
a housing containing the wireless communication circuitry; and
a port accessible in a side of the housing and electronically connected to the wireless communication circuitry;
and wherein:
the wireless access point circuitry is contained in a separate housing from the housing of the wireless access point device; and
the wireless access point circuitry can be attached to and detached from the port of the wireless access point device.

9. The wireless access point device of claim 1, further comprising:
a housing containing the wireless communication circuitry and the wireless access point circuitry.

10. The wireless access point device of claim 1, further comprising:
an antenna through which both the wireless communication circuitry and the wireless access point circuitry transmit.

11. The wireless access point device of claim 10, further comprising:
a time-domain multiplexer that selects back and forth between the wireless communication circuitry and the wireless access point circuitry to transmit through the antenna.

12. The wireless access point device of claim 1, wherein:
the wireless unit comprises a wireless tag attached to an object;
the wireless tag transmits identification information; and
the wireless access point device monitors the wireless tag.

13. The wireless access point device of claim 12, wherein:
the wireless tag also transmits target information specifying a target device;
by monitoring the wireless tag, the wireless access point device receives the identification information and the target information; and
the wireless access point device transmits the identification information to the target device specified by the target information.

14. The wireless access point device of claim 1, wherein:
the wireless access point circuitry is a Wi-Fi access point circuitry;
the wireless unit is a Wi-Fi device; and
the Wi-Fi access point circuitry enables the Wi-Fi device to wirelessly access the wireless communication network through the wireless access point device.

15. The wireless access point device of claim 1, wherein:
the wireless access point device enables the wireless unit to seamlessly connect to the wireless communication network.

16. A method of wirelessly accessing a wireless communication network, comprising:
setting a wireless access point device to accept access by a wireless unit, the wireless access point device having a wireless communication circuitry and a wireless access point circuitry, and the wireless access point device having access to the wireless communication network through the wireless communication circuitry;
establishing a wireless connection between the wireless unit and the wireless access point device, the wireless unit having a wireless adapter for wirelessly communicating with the wireless access point circuitry; and
connecting the wireless unit to the wireless communication network using the wireless adapter, the wireless access point circuitry and the wireless communication circuitry.

17. The method of claim 16, wherein the wireless access point device is a mobile device.

18. The method of claim 16, further comprising:
the wireless access point device entering a low-power mode when no data is being transferred between the wireless access point device and the wireless unit.

19. The method of claim 16, further comprising:
setting the wireless access point device to accept access by a plurality of the wireless units, the wireless access point device further having a router;
establishing a wireless connection between the wireless units and the wireless access point device, the wireless units having wireless adapters for wirelessly communicating with the wireless access point circuitry and the router; and
connecting the wireless units to the wireless communication network through the wireless adapter, the wireless access point circuitry, the router and the wireless communication circuitry.

20. The method of claim 16, further comprising:
controlling the wireless access point device by a host processor; and
running a program on the host processor enabling the host processor to use the wireless access point circuitry, the program contained in less than 1 MB of a memory associated with the host processor.

21. The method of claim 20, further comprising:
controlling functions of the wireless access point circuitry by a microcontroller, separate from the host processor.

22. The method of claim 16, wherein:
the wireless access point device also has a housing containing the wireless communication circuitry and a port accessible at a side of the housing and electronically connected to the wireless communication circuitry;
the wireless access point circuitry is contained in a housing separate from the housing of the wireless access point device; and
the method further comprises attaching the wireless access point circuitry to and detaching the wireless access point circuitry from the port.

23. The method of claim 16, wherein the wireless access point device also has a housing containing both the wireless communication circuitry and the wireless access point circuitry.

24. The method of claim 16, wherein:
the wireless access point device also has an antenna; and
the method further comprises both the wireless communication circuitry and the wireless access point circuitry transmitting through the antenna.

25. The method of claim 24, wherein:
the wireless access point device also has a time-domain multiplexer; and
the method further comprises the time-domain multiplexer selecting back and forth between the wireless communication circuitry and the wireless access point circuitry to transmit through the antenna.

26. The method of claim 16, wherein:
the wireless unit comprises a wireless tag attached to an object; and
the method further comprises:
the wireless tag transmitting identification information; and
the wireless access point device monitoring for transmissions from the wireless tag.

27. The method of claim 26, further comprising:
the wireless tag also transmitting target information specifying a target device;
the wireless access point device receiving the identification information and the target information; and
the wireless access point device transmitting the identification information to the target device specified by the target information.

28. The method of claim 16, wherein:
the wireless unit comprises a Wi-Fi device and the wireless adapter thereof comprises a Wi-Fi adapter;
the wireless access point device comprises a Wi-Fi access point device and the wireless access point circuitry thereof comprises a Wi-Fi access point; and
the method further comprises establishing a Wi-Fi connection between the Wi-Fi device and the Wi-Fi access point device via the Wi-Fi adapter and the Wi-Fi access point.

29. The method of claim 16, further comprising:
seamlessly establishing the wireless connection between the wireless unit and the wireless access point device; and
seamlessly connecting the wireless unit to the wireless communication network.
